(19) United States
(12) Patent Application Publication
(10) Pub. No.: US 2025/0128607 A1
(43) Pub. Date: Apr. 24, 2025

(54) VEHICLE CONTROL APPARATUS AND VEHICLE CONTROL METHOD

(71) Applicant: Hitachi Astemo, Ltd., Hitachinaka-shi, Ibaraki (JP)

(72) Inventors: Hao YU, Hitachinaka-shi, Ibaraki (JP); Rikiya YOSHIZU, Hitachinaka-shi, Ibaraki (JP); Shotaro ITO, Hitachinaka-shi, Ibaraki (JP)

(21) Appl. No.: 18/692,005

(22) PCT Filed: Sep. 20, 2022
(86) PCT No.: PCT/JP2022/034871

§ 371 Date: Mar. 14, 2024

(30) Foreign Application Priority Data
Nov. 30, 2021 (JP) 2021-194100

(51) Int. Cl. B60L 7/26

(52) U.S. Cl. CPC B60L 7/26

(57) ABSTRACT

A braking mechanism is configured to press a brake pad against a disk rotor that rotates together with a wheel. An ECU includes a control portion configured to control the braking mechanism. The control portion acquires a control condition including at least one of information regarding a running environment of a running road on which a vehicle runs or information regarding a state of the vehicle. The control portion controls a clearance amount between the disk rotor and the brake pad independently for each of wheels of the vehicle based on the acquired control condition.

### TECHNICAL FIELD

The present invention relates to a vehicle control apparatus and a vehicle control method.

### BACKGROUND ART

PTL 1 discloses an electric brake apparatus including a rotational member, a frictional member configured to be moved into contact with the rotational member, a frictional member operation unit configured to generate a braking force by moving the frictional member into contact with the rotational member, an electric motor configured to drive the frictional member operation unit, and a control device capable of adjusting a clearance amount, which is a space between the rotational member and the frictional member, by controlling the electric motor. The control device of this electric brake apparatus includes a monitoring unit configured to monitor a vehicle speed detected by a vehicle speed detector and an accelerator operation amount detected by an accelerator operation amount detector when no brake operation is performed, and a clearance change unit configured to change the clearance amount when a set condition is satisfied by any one or both of the vehicle speed and the accelerator operation amount monitored by the monitoring unit.

### CITATION LIST

### Patent Literature

PTL 1: Japanese Patent Application Laid-Open No. 2017-56746

### SUMMARY OF INVENTION

### Technical Problem

However, PTL 1 does not set the clearance amount, which is the space between the rotational member and the frictional member, for each of four wheels individually. This may make it difficult to prevent a reduction in the brake performance while also preventing an increase in the drag torque at the same time.

### Solution to Problem

One of objects of the present invention is to provide a vehicle control apparatus and a vehicle control method that can prevent a reduction in the brake performance while also preventing an increase in the drag torque at the same time.

According to one aspect of the present invention, a vehicle control apparatus includes a control portion configured to control a braking mechanism. The braking mechanism is configured to press a frictional pad against a rotor that rotates together with a wheel. The control portion acquires a control condition including at least one of information regarding a running environment of a running road on which a vehicle runs or information regarding a state of the vehicle, and controls a clearance amount between the rotor and the frictional pad independently for each of wheels of the vehicle based on the control condition.

Further, according to one aspect of the present invention, a vehicle control method is configured to be performed by a control unit mounted on a vehicle including a braking mechanism. The braking mechanism is configured to press a frictional pad against a rotor that rotates together with a wheel. The vehicle control method includes causing the control unit to acquire a control condition including at least one of information regarding a running environment of a running road on which a vehicle runs or information regarding a state of the vehicle, and control a clearance amount between the rotor and the frictional pad independently for each of wheels of the vehicle based on the control condition.

According to the one aspect of the present invention, both a reduction in the brake performance and an increase in the drag torque can be prevented at the same time.

### BRIEF DESCRIPTION OF DRAWINGS

FIG. 1 is a schematic view illustrating a vehicle on which a vehicle control apparatus according to an embodiment is mounted.

FIG. 2 is a perspective view illustrating an electric brake apparatus illustrated in FIG. 1.

FIG. 3 is a cross-sectional view illustrating the electric brake apparatus illustrated in FIG. 1.

FIG. 4 is a flowchart illustrating processing for controlling clearances by a first ECU (and/or a second ECU) illustrated in FIG. 1.

FIG. 5 is a flowchart illustrating processing subsequent to “A” in FIG. 4.

FIG. 6 illustrates characteristic lines indicating examples of the relationships between a clearance amount, and responsiveness and a drag torque.

### DESCRIPTION OF EMBODIMENTS

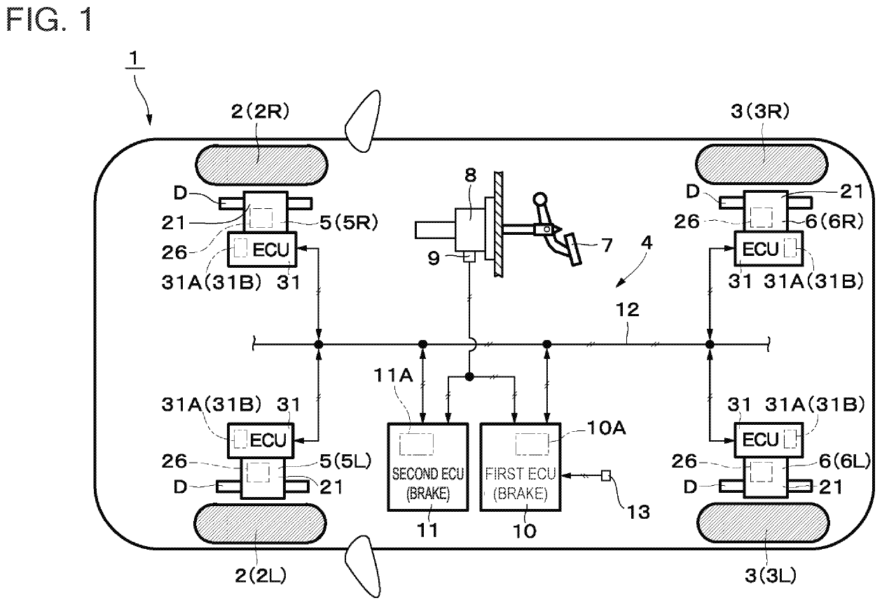

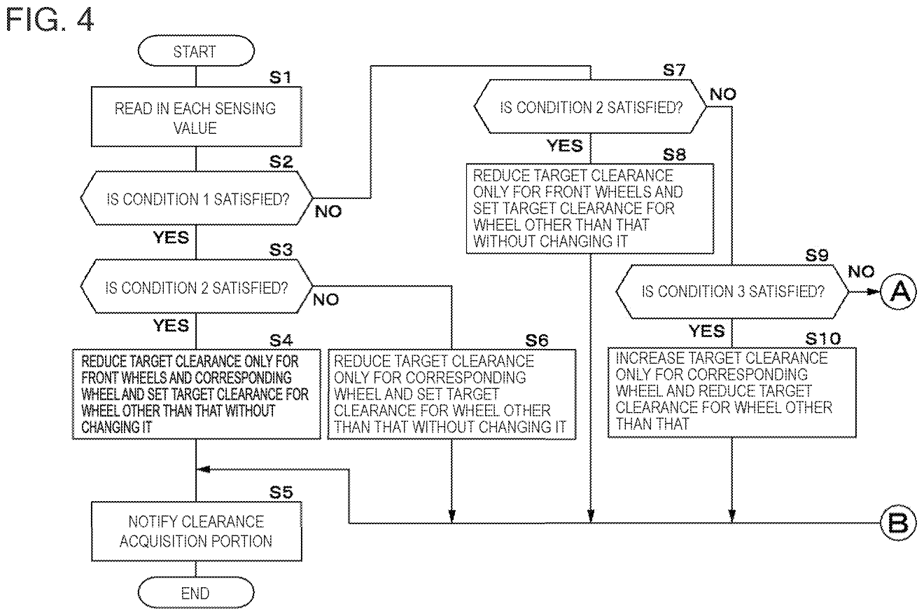

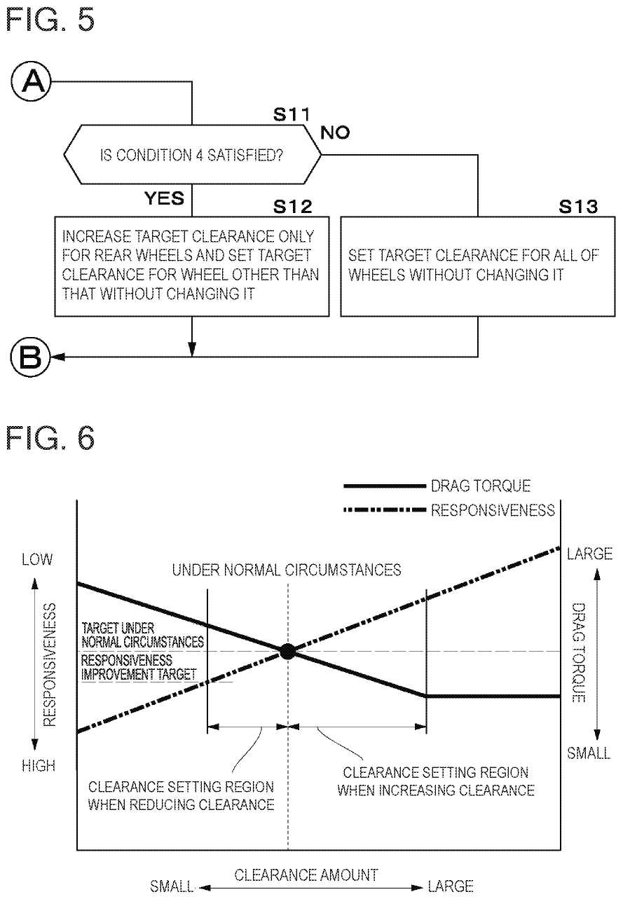

In the following description, a vehicle control apparatus and a vehicle control method according to an embodiment will be described citing an example in which they are applied to a four-wheeled automobile with reference to the accompanying drawings. Each of steps in flowcharts illustrated in FIGS. 4 and 5 will be represented by the symbol “S” (for example, assume that step 1 is indicated like step 1=“S1”). Further, a line with two slash marks added thereto in FIG. 1 indicates an electricity-related line. Further, indexes “L” and “R” correspond to “left” and “right”, respectively.

FIG. 1 illustrates a vehicle system. In FIG. 1, a vehicle 1 is equipped with a brake system 4, which applies braking forces to wheels 2 and 3 (front wheels 2L and 2R and rear wheels 3L and 3R) to brake the vehicle 1. The brake system 4 includes left and right front wheel-side electric brake apparatuses 5L and 5R (front braking apparatuses), left and right rear wheel-side electric brake apparatuses 6L and 6R (rear braking apparatuses), a brake pedal 7 (an operation tool), a pedal reaction force device 8 (hereinafter referred to as a pedal simulator 8), and a pedal stroke sensor 9. The left and right front wheel-side electric brake apparatuses 5L and 5R are provided in correspondence with the front wheel 2L on the left side (the left front wheel 2L) and the front wheel 2R on the right side (the right front wheel 2R). The left and right rear wheel-side electric brake apparatuses 6L and 6R are provided in correspondence with the rear wheel 3L on the left side (the left rear wheel 3L) and the rear wheel 3R on the right side (the right rear wheel 3R). The brake pedal 7 serves as a brake operation member. The pedal simulator 8 generates a kickback reaction force according to an operation (pressing) on the brake pedal 7. The pedal stroke sensor 9 serves as an operation detection sensor that measures the amount of the operation performed by an operator (a driver) on the brake pedal 7.

The left and right front wheel-side electric brake apparatuses 5L and 5R and the left and right rear wheel-side electric brake apparatuses 6L and 6R (hereinafter also referred to as the electric brake apparatuses 5 and 6) are each configured as, for example, an electric disk brake (an electrically-driven disk brake). The electric brake apparatuses 5 and 6 apply the braking forces to the wheels 2 and 3 (the front wheels 2L and 2R and the rear wheels 3L and 3R) based on driving of electric motors 26. Further, for example, the left and right rear wheel-side electric brake apparatuses 6L and 6R each include a parking mechanism (not illustrated).

The pedal stroke sensor 9 is provided on, for example, the pedal simulator 8. The pedal stroke sensor 9 may be provided on the brake pedal 7. Further, a pressing force sensor that measures a pressing force corresponding to the amount of the operation on the brake pedal 7 may be used instead of the pedal stroke sensor 9. The pedal stroke sensor 9 is connected to a first brake control ECU 10 and a second brake control ECU 11, each of which is an ECU (Electronic Control Unit) for brake control.

The first brake control ECU 10 (also referred to as the first ECU 10) and the second brake control ECU 11 (also referred to as the second ECU 11) are provided to the vehicle 1. The first ECU 10 and the second ECU 11 each include a microcomputer equipped with an arithmetic processing unit (a CPU), a storage device (a memory), a control board, and the like. The first ECU 10 and the second ECU 11 calculate the braking force (a target braking force) for each of the wheels (the four wheels) according to a predetermined control program in reaction to an input of a signal from the pedal stroke sensor 9.

The first ECU 10 calculates, for example, the target braking forces that should be applied to the left-side front wheel 2L and the right-side rear wheel 3R. The first ECU 10 outputs (transmits) braking instructions (control instructions) directed to the two wheels, the left-side front wheel 2L and the right-side rear wheel 3R to electric brake ECUs 31 and 31 via a CAN 12 (Control Area Network) serving as a vehicle data bus based on the calculated target braking forces, respectively.

The second ECU 10 calculates, for example, the target braking forces that should be applied to the right-side front wheel 2R and the left-side rear wheel 3L. The second ECU 11 outputs (transmits) braking instructions (control instructions) directed to the two wheels, the right-side front wheel 2R and the left-side rear wheel 3L to electric brake ECUs 31 and 31 via the CAN 12 based on the calculated target braking forces, respectively.

To perform such control regarding braking, the first ECU 10 and the second ECU 11 include control portions 10A and 11A, respectively. The control portions 10A and 11A make a calculation based on input information (for example, the signal from the pedal stroke sensor 9) and output a result of this calculation (for example, a control instruction according to a target thrust force). The first ECU 10 and the second ECU 11 receive vehicle information transmitted from another ECU mounted on the vehicle 1 (for example, an engine mover ECU, a transmission ECU, a steering ECU, or an autonomous driving ECU, which are not illustrated) via the CAN 12.

For example, the first ECU 10 and the second ECU 11 can acquire various kinds of vehicle information such as information about the position of an automatic transmission range selector or the position of a manual transmission shifter, information about ON/OFF of an ignition, information about an engine rotational speed, information about a power train torque, information about a transmission gear ratio, information about an operation on a steering wheel, information about a clutch operation, information about an accelerator operation, information about inter-vehicle communication, information about surroundings around the vehicle that is acquired by an in-vehicle camera, and information about an acceleration sensor (a longitudinal acceleration and a lateral acceleration) via the CAN 12. Further, as will be described below, the first ECU 10 and the second ECU 11 can acquire temperature information regarding braking, such as the temperatures of the wheels 2 and 3 (the front wheels 2L and 2R and the rear wheels 3L and 3R), the temperature of the disk rotor D, the temperature of the brake pad 25, or the temperature of the braking mechanism 21, via the CAN 12.

A parking brake switch 13 is provided near the driver's seat. The parking brake switch 13 is connected to the first ECU 10 (and the second ECU 11 via the CAN 12). The parking brake switch 13 transmits a signal (an actuation request signal) corresponding to a request to actuate the parking brake (an application request working as a holding request or a release request working as an end request) according to an operation instruction from the driver to the first ECU 10 and the second ECU 11. The first ECU 10 and the second ECU 11 transmit a parking brake instruction directed to each of the two rear wheels (the rear wheels 3L and 3R) to each of the electric brake ECUs 31 and 31 based on an operation on the parking brake switch 13 (the actuation request signal). The parking brake switch 13 corresponds to a switch that actuates the parking mechanism.

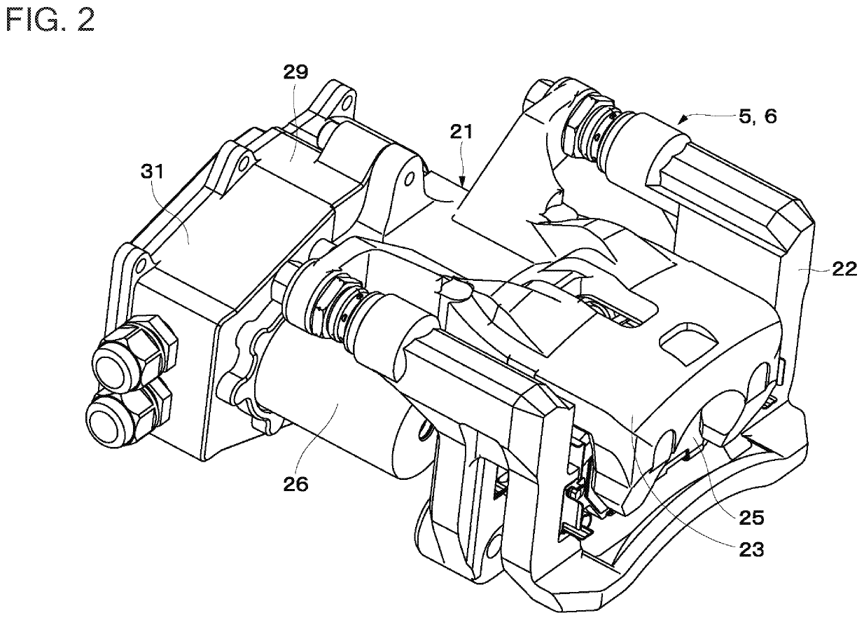

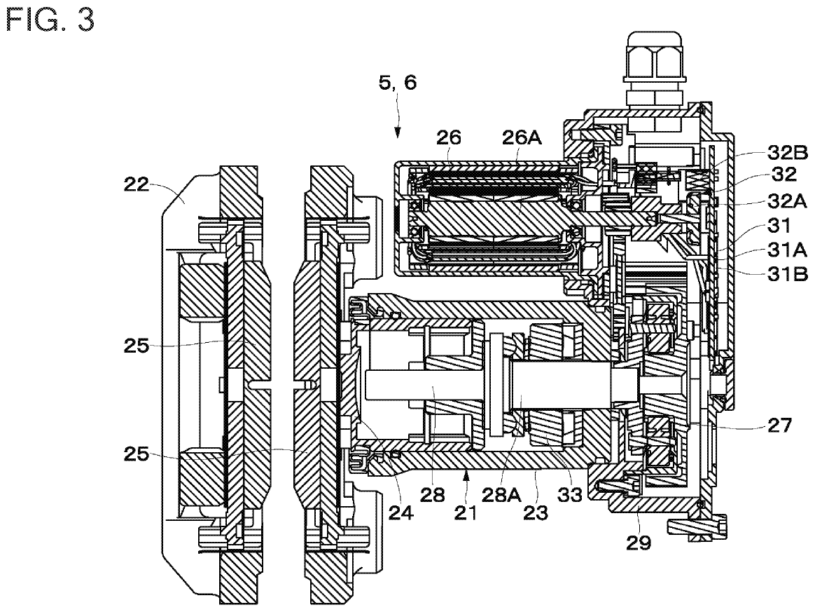

FIGS. 2 and 3 illustrate each of the electric brake apparatuses 5 and 6. The electric brake apparatuses 5 and 6 each include the braking mechanism 21, the electric motor 26, and the electric brake ECU 31. The electric brake apparatuses 5 and 6 each apply the braking force to the vehicle 1 by controlling the position and the thrust force of the braking mechanism 21. To achieve this function, the braking mechanism 21 includes a rotational angle sensor 32 (FIG. 3), a thrust force sensor 33 (FIG. 3), and a current sensor (not illustrated). The rotational angle sensor 32 serves as a position detection unit that detects a motor rotational position. The thrust force sensor 33 serves as a thrust force detection unit that detects a thrust force (a piston thrust force) generated on a piston 24. The current sensor serves as a current detection unit that detects a current of the electric motor 26 (a motor current).

The braking mechanism 21 includes, for example, a carrier 22, a caliper 23 as a cylinder (a wheel cylinder), the piston 24 as a pressing member, and brake pads 25 as a braking member (a frictional pad). The electric motor 26 is provided to the braking mechanism 21 to drive the braking mechanism 21, i.e., generate the braking force. Further, the braking mechanism 21 includes a speed reduction mechanism 27, a rotation-linear motion conversion mechanism 28, and a not-illustrated fail-open mechanism (a return spring). The speed reduction mechanism 27 is covered by a housing 29 together with an ECU board 31B of the electric brake ECU 31. The housing 29, the speed reduction mechanism 27, the electric motor 26, the rotational angle sensor 32, and the ECU board 31B constitute a drive member that drives the braking mechanism 21.

The carrier 22 is fixed to the vehicle body side of the vehicle 1. The caliper 23 is supported on the carrier 22 movably in the axial direction of the disk rotor D (supported in a floating manner). The electric motor 26 rotates according to supply of electric power thereto, and thrusts forward the piston 24. By this operation, the electric motor 26 provides the braking force. The electric motor 26 is controlled by the electric brake ECU 31 based on the braking instruction (the control instruction) issued from the first ECU 10 or the second ECU 11. The speed reduction mechanism 27 is formed by, for example, a gear speed reduction mechanism, and transmits the rotation of the electric motor 26 to the rotation-linear motion conversion mechanism 28 while slowing down it.

The rotation-linear motion conversion mechanism 28 converts the rotation of the electric motor 26 transmitted via the speed reduction mechanism 27 into an axial displacement of the piston 24 (a linear-motion displacement). The piston 24 is thrust forward according to the driving of the electric motor 26, and moves the brake pads 25. The brake pads 25 are pressed against the disk rotor D by the piston 24. The pair of brake pads 25 and 25 is located on the both axial sides of the disk rotor D, and is each supported on the carrier 22. The disk rotor D as a braked member (a rotor) rotates together with the wheel 2L, 2R, 3L, or 3R.

When the braking is applied, the not-illustrated return spring (the fail-open mechanism) applies a rotational force to a rotational member of the rotation-linear motion conversion mechanism 28 in a braking release direction. In the braking mechanism 21, the piston 24 is thrust forward so as to press the brake pads 25 against the disk rotor D according to the driving of the electric motor 26. In other words, the braking mechanism 21 transmits the thrust force generated according to the driving of the electric motor 26 to the piston 24, which moves the brake pads 25, based on the braking request (the braking instruction). Due to that, the braking mechanism 21 presses the brake pads 25 against the disk rotor D.

As illustrated in FIG. 1, the electric brake ECU 31 is provided in correspondence with each of the braking mechanisms 21. The electric brake ECU 31 includes, for example, a microcomputer including an arithmetic processing unit (a CPU), a storage device (a memory), a control board, and the like, and a drive circuit for supplying electric power to the electric motor 26 (for example, an inverter). As illustrated in FIG. 3, the electric brake ECU 31 includes the ECU board 31B with an arithmetic circuit and the like mounted thereon. The electric brake ECU 31 controls the electric motor 26, which actuates the braking mechanism 21, based on the instruction from the first ECU 10 or the second ECU 11.

The electric brake ECU 31 includes a control portion 31A (i.e., the ECU board 31B). The control portion 31A makes a calculation based on input information (for example, the signal corresponding to the control instruction) and outputs a result of this calculation (for example, an electric motor drive instruction according to the control instruction). The electric brake ECU 31 constitutes a control apparatus (the brake control apparatus) that controls the electric motor 26 together with the first ECU 10 and the second ECU 11. In this case, the electric brake ECU 31 controls the driving of the electric motor 26 based on the braking instruction (the control instruction) input to the electric brake ECU 31. Further, the electric brake ECU 31 on the rear wheel side controls driving (an application and a release) of the parking mechanism based on the parking actuation instruction input to this electric brake ECU 31. The signal corresponding to the braking instruction or the signal corresponding to the parking actuation instruction is input from the first ECU 10 or the second ECU 11 to the electric brake ECU 31.

The rotational angle sensor 32 detects the rotational angle of a rotational shaft 26A of the electric motor 26 (a motor rotational angle). The rotational angle sensor 32 is provided in correspondence with each of the respective electric motors 26 of the braking mechanisms 21, and constitutes the position detection unit that detects the rotational position of the electric motor 26 (the motor rotational position) and thus the position of the piston 24 (a piston position). The rotational angle sensor 32 includes, for example, a magnet 32A and a magnetic detection IC chip 32B. The magnet 32A is a magnet member attached on the rotational shaft 26A of the electric motor 26. The magnetic detection IC chip 32B is a magnet signal reception portion provided on the electric brake ECU 31 (the ECU board 31B). The electric brake ECU 31 (the ECU board 31B) can calculate and detect the rotational angle of the rotational shaft 26A of the electric motor 26 by detecting a change in a magnetic flux of the rotating magnet 32A using the magnetic detection IC chip 32B.

The thrust force sensor 33 detects a reaction force to the thrust force (the pressing force) applied from the piston 24 to the brake pads 25. The thrust force sensor 33 is provided to each of the braking mechanisms 21, and constitutes the thrust force detection unit that detects the thrust force generated on the piston 24 (the piston thrust force). The thrust force sensor 33 is provided on the rotation-linear motion conversion mechanism 28. The not-illustrated current sensor detects the current supplied to the electric motor 26 (the motor current). The current sensor is provided in correspondence with each of the respective electric motors 26 of the braking mechanisms 21, and constitutes the current detection unit that detects the current supplied to the electric motor 26 (the motor current or a motor torque current). The rotational angle sensor 32, the thrust force sensor 33, and the current sensor are connected to the electric brake ECU 31.

The electric brake ECU 31 (and the first ECU 10 and the second ECU 11 connected to this electric brake ECU 31 via the CAN 12) can acquire the rotational angle of the electric motor 26 based on the signal from the rotational angle sensor 32. The electric brake ECU 31 (and the first ECU 10 and the second ECU 11) can acquire the thrust force generated on the piston 24 based on the signal from the thrust force sensor 33. The electric brake ECU 31 (and the first ECU 10 and the second ECU 11) can acquire the motor current supplied to the electric motor 26 based on the signal from the current sensor.

Next, the operations of applying the braking and releasing the braking by the electric brake apparatuses 5 and 6 will be described. In the following description, these operations will be described citing the operations when the driver operates the brake pedal 7 as an example. However, the electric brake apparatuses 5 and 6 also operate approximately similarly even in the case of autonomous brake, except that the operations in this case are different in terms of, for example, the fact that an instruction for the autonomous brake is output from the autonomous brake ECU (not illustrated), the first ECU 10, or the second ECU 11 to the electric brake ECU 31.

For example, when the driver operates the brake pedal 7 by pressing it while the vehicle 1 runs, the first ECU 10 and the second ECU 11 each output an instruction according to the operation of pressing the brake pedal 7 (the control instruction according to the target thrust force instruction value) to the electric brake ECU 31 based on the detection signal input from the pedal stroke sensor 9. The electric brake ECU 31 drives (rotates) the electric motor 26 in a forward direction, i.e., in a braking application direction based on the instruction from the first ECU 10 or the second ECU 11. The rotation of the electric motor 26 is transmitted to the rotation-linear motion conversion mechanism 28 via the speed reduction mechanism 27, and the piston 24 is moved forward toward the brake pads 25.

As a result, the brake pads 25 are pressed against the disk rotor D, and the braking force is applied. At this time, the braking state is established due to the control on the driving of the electric motor 26 based on the detection signals from the pedal stroke sensor 9, the rotational angle sensor 32, the thrust force sensor 33, and the like. While such control is ongoing, the force in the braking release direction is applied to the rotational member 28A of the rotation-linear motion conversion mechanism 28 and thus the rotational shaft 26A of the electric motor 26 by the not-illustrated return spring provided to the braking mechanism 21.

On the other hand, when the brake pedal 7 is operated toward a pressing release side, the first ECU 10 and the second ECU 11 each output an instruction according to this operation (the control instruction according to the target thrust force instruction value) to the electric brake ECU 31. The electric brake ECU 31 drives (rotates) the electric motor 26 in a reverse direction, i.e., in a braking release direction based on the instruction from the first ECU 10 or the second ECU 11. The rotation of the electric motor 26 is transmitted to the rotation-linear motion conversion mechanism 28 via the speed reduction mechanism 27, and the piston 24 is moved backward in a direction away from the brake pads 25. Then, when the pressing of the brake pedal 7 is completely released, the brake pads 25 are separated from the disk rotor D, and the braking force is released. In a non-braking state where the braking is released in this manner, the not-illustrated return spring provided to the braking mechanism 21 is returned to the initial state thereof.

Next, the thrust force control and the position control by the electric brake apparatuses 5 and 6 will be described.

The first ECU 10 and the second ECU 11 determine a braking force that should be generated by each of the electric brake apparatuses 5 and 6, i.e., the target thrust force that should be generated on the piston 24 based on the detection data from the various kinds of sensors (for example, the pedal stroke sensor 9), the autonomous brake instruction, and/or the like. The first ECU 10 and the second ECU 11 each output the braking instruction (the control instruction) according to the target thrust force to the electric brake ECU 31. The electric brake ECU 31 performs the thrust force control based on the piston thrust force detected by the thrust force sensor 33 as feedback and performs the position control based on the motor rotational position detected by the rotational angle sensor 32 as feedback on the electric motor 26 so as to generate the target thrust force on the piston 24.

In other words, in the braking mechanism 21, the thrust force of the piston 24 is adjusted based on the braking instruction (the target thrust force) from the first ECU 10 or the second ECU 11 and the feedback signal from the thrust force sensor 33, which measures the thrust force of the piston 24. To determine the thrust force, the braking mechanism 21 controls the torque of the electric motor 26 via the rotation-linear motion conversion mechanism 28 and the speed reduction mechanism 27, i.e., controls the current based on a feedback signal of the current sensor, which measures the current amount supplied to the electric motor 26. The braking force, and the piston thrust force, the torque of the electric motor 26 (the motor torque), the current value, and the piston position (a rotational speed measured value of the electric motor 26 that is measured by the rotational angle sensor 32) are in a correlated relationship.

The braking force (the brake force) exerted by the electric brake apparatus 5 or 6 is generated by pressing the brake pads 25 against the disk rotor D. At this time, the braking request of the driver is detected by the pedal stroke sensor 9. The driver's braking request detected by the pedal stroke sensor 9 is input to the electric brake ECU 31 (the ECU board 31B) as the braking instruction from the first ECU 10 or the second ECU 11. The electric brake ECU 31 (the ECU board 31B) controls the electric motor 26 based on the braking instruction corresponding to the driver's request and the signal from the thrust force sensor 33 (the signal corresponding to the thrust force).

The torque generated on the electric motor 26 is amplified by the speed reduction mechanism 27, and is converted into the thrust force, i.e., the axial thrust force of the piston 24 by the rotation-linear motion conversion mechanism 28 and causes the brake pads 25 to be pressed against the disk rotor D by the piston 24. Further, the electric motor 26 is controlled by detecting the rotational angle of the rotational shaft 26A, which indicates the rotational angle of the electric motor 26, by means of the rotational angle sensor 32. In other words, the electric motor 26 is controlled by detecting a change in the magnetic flux of the magnet 32A rotating together with the rotational shaft 26A by means of the magnetic detection IC chip 32B, which serves as the magnet signal reception portion. At this time, a clearance amount between the brake pad 25 and the disk rotor D can be adjusted by controlling the position of the piston 24 using the rotational angle of the electric motor 26 detected by the rotational angle sensor 32.

Then, because brake apparatuses are essential safety components of vehicles, the improvement of the responsiveness is important. On the other hand, for brake apparatuses, an increase in the drag torque is undesirable from an environmental perspective and an economic perspective such as the fuel efficiency and the electric power efficiency of vehicles and the wear of the frictional pads. Then, the electric brake apparatus of the above-described patent literature, PTL 1 changes the clearance amount, which is the space between the rotational member and the frictional member, when the set condition is satisfied by any one or both of the vehicle speed and the accelerator operation amount. However, the above-described patent literature, PTL 1 does not set the adjustment of the clearance amount, which is the space between the rotational member and the frictional member, for each of the four wheels individually.

This may make it difficult to prevent a reduction in the brake performance as a whole of the vehicle (for example, the braking timing, the responsiveness, and the braking function) and also prevent an increase in the drag torque at the same time. More specifically, the electric brake apparatus of PTL 1 narrows the clearance for all of the four wheels at once, and therefore may cause an increase in the drag torque according thereto, leading to the deterioration of the fuel efficiency and the wear of the pads. This makes it difficult to “prevent a reduction in the brake performance” as a whole of the vehicle and also “prevent an increase in the drag torque” at the same time.

In light thereof, the embodiment controls the clearance between the brake pad and the brake rotor (the disk rotor) independently for each of the four wheels according to the running scene of the vehicle or the state of the actuator (the electric motor, the braking mechanism, or the like). The details thereof will be described now.

For example, the clearance is controlled in the following manner when the maximum current cannot be supplied to the electric motor for brake control as the state (the condition) of the vehicle. More specifically, when the electric motor for brake control is placed in an overheated state, this causes a failure to supply the maximum current to this electric motor. Alternatively, when the voltage of the electric power source that supplies electric power to the electric brake apparatus reduces due to, for example, a reduction in the battery charge, this causes a failure to supply the maximum current to the electric motor. In such a vehicle state (condition), the clearance is narrowed in advance only for a wheel corresponding to the electric motor to which the maximum current cannot be supplied. This makes it possible to compensate for the responsiveness of the electric brake apparatus of this wheel, i.e., a reduction in the responsiveness due to the failure to supply the maximum current. As a result, the timing of generating the braking force can be adjusted as intended on each of the four wheels.

Alternatively, for example, the clearance is controlled in the following manner when the vehicle is predicted to be braked as the running environment or the state (the condition) of the vehicle. More specifically, the vehicle is predicted to be braked when running on a narrow road or a road in a complicated road condition as the running environment. Alternatively, the vehicle is predicted to be braked when the accelerator pedal is released as the state (the condition) of the vehicle. In such a running environment or a state (condition) of the vehicle, the clearance is narrowed in advance only for the two front wheels among the four wheels, i.e., the four wheels subjected to a high wheel load and more contributive to the brake force than the rear wheels at the time of deceleration. As a result, the responsiveness can be improved while an increase in the drag torque is prevented compared to when the clearance is narrowed for all of the four wheels.

Alternatively, for example, the clearance is controlled in the following manner when brake control performed independently for each of the four wheels is predicted to intervene as the running environment. More specifically, when the vehicle enters a curve as the running environment or when the frictional coefficient between the tire and the road surface is expected to be low due to a bad-conditioned road such as a muddy road, a rainy road, or a snowy road, the brake control performed independently for each of the four wheels is predicted to intervene. Alternatively, when the vehicle is likely to deviate from the traffic lane, the distance between vehicles is short, or an obstacle is present ahead of the vehicle, the brake control performed independently for each of the four wheels is also predicted to intervene. Examples of the brake control performed independently for each of the four wheels include sideslip prevention control (ESC: Electronic Stability Control), GV control (GVC: G-Vectoring Control), moment control (M+C: Moment plus Control), and collision mitigation brake control (AEBC: Autonomous Emergency Braking Control).

When such brake control performed independently for each of the four wheels is predicted to intervene, the clearance is narrowed in advance only for a wheel targeted for this brake control (a corresponding wheel). As a result, the responsiveness can be improved while an increase in the drag torque is prevented. The GV control controls acceleration/deceleration by generating approximately equal driving forces or braking forces on left and right wheels among the four wheels based on an acceleration/deceleration instruction value calculated based on a lateral jerk of the vehicle. The moment control controls a yaw moment by generating different driving forces or braking forces on left and right wheels among the four wheels based on a vehicle yaw moment instruction value calculated based on the lateral jerk. Such GV control (G-Vectoring control) and moment control (Moment+control) are discussed in, for example, Japanese Patent Application Laid-open No. 2014-069766.

Alternatively, for example, the clearance is controlled in the following manner when the temperature of the frictional pad increases as the state (the condition) of the vehicle. More specifically, the temperature increases due to friction between the rotor and the frictional pad immediately after sudden brake or immediately after the vehicle runs on a downward slope. When this temperature increase is significant, a brake fade phenomenon may occur and impair the effect of the brake. In this case, the clearance is widened for a wheel subjected to a great heat increase, and is narrowed for a wheel other than that. As a result, the rotor and the frictional pad can be highly efficiently air-cooled on the wheel where the clearance is widened, and the brake performance can be maintained. Further, the responsiveness can also be ensured by narrowing the clearance for the wheel other than the overheated wheel.

Alternatively, for example, the clearance is controlled in the following manner when the vehicle is less likely to be braked suddenly as the running condition or when the required braking force can be supplemented by regenerative brake as the state (condition) of the vehicle. More specifically, it is considered that the vehicle is less likely to be braked suddenly when no obstacle or vehicle is present around the vehicle on a wide road in a simple road condition as the running environment. Under such a running environment, the clearance is widened only for the two rear wheels among the four wheels, i.e., the rear wheels less contributive to the brake force than the front wheels. As a result, while the drag torque is reduced, the responsiveness can also be ensured.

Further, a vehicle equipped with an electric motor for vehicle driving, such as an electric automobile (EV: Electric Vehicle), a hybrid automobile (HEV: Hybrid Electric Vehicle), and a plug-in hybrid automobile (PHEV: Plug-in Hybrid Electric Vehicle), can collect motive power with the aid of regeneration by the electric motor for vehicle driving during coasting (during free-wheeling). A regenerative torque varies depending on the charge amount, and the required braking force may be able to be achieved by the regenerative brake alone in some state (condition). In such a case, i.e., while the required braking force is achieved by the regenerative brake alone, the clearance is widened only for the two rear wheels among the four wheels. As a result, the drag torque can be reduced.

In this manner, in the embodiment, the clearance amount between the brake pad 25 and the disk rotor D is controlled independently for each of the wheels 2L, 2R, 3L, and 3R according to the running environment of the running road on which the vehicle 1 runs or the state (condition) of the vehicle 1. To realize this function, a processing program for performing processing flows illustrated in FIGS. 4 and 5, i.e., a program used for processing for determining clearance independent control is stored in the memory of at least one of the first ECU 10, the second ECU 11, and the electric brake ECU 31.

Then, the vehicle 1 includes a sensing unit that detects the running environment of the vehicle 1 and/or the state of the vehicle 1 (the vehicle state) to adjust the clearance amount independently for each of the wheels 2L, 2R, 3L, and 3R. Examples of the sensing unit include an in-vehicle camera, a radar, a wheel speed sensor, and a temperature sensor mounted on the braking mechanism 21. In the embodiment, the running environment of the vehicle 1 or the condition of the vehicle 1 (the condition) is detected by such a sensing unit, and the clearance amount is adjusted independently for each of the wheels 2L, 2R, 3L, and 3R based on a result of this detection.

In this case, the state of the vehicle I such as a vehicle motion state may be detected using a sensor value detected from a motion state detection sensor such as a wheel speed sensor, a longitudinal acceleration sensor, a vertical acceleration sensor, a lateral acceleration sensor, and a yaw rate sensor mounted on the vehicle 1, or may be detected using an estimated value (a calculated value) estimated (calculated) from the running environment. In the embodiment, how the clearance amount should be adjusted for each of the wheels 2L, 2R, 3L, and 3R is classified into the following four conditions, a “condition 1 (a first condition)”, a “condition 2 (a second condition)”, a “condition 3 (a third condition)”, and a “condition 4 (a fourth condition)”.

The “condition 1” corresponds to reducing the clearance amount from a reference clearance amount, which is a clearance amount under normal circumstances, only for the corresponding wheel (a target wheel) based on the running environment such as the road state (the road condition) or the vehicle state. This case aims at two purposes “improving the responsiveness” and “adjusting the timing of generating the braking force as intended”. A control loss time can be compensated for by improving the responsiveness. In other words, a control loss time is present since the brake pedal 7 is pressed until the braking force is generated.

Therefore, the control loss time is compensated for by reducing the clearance amount from the reference clearance amount by an amount corresponding to the loss time. Further, the braking forces on the four wheels can be balanced by adjusting their timings as intended. More specifically, the braking force is generated at a delayed timing on the braking mechanism 21 of the electric motor 26 to which the maximum current cannot be supplied. Therefore, in this case, the delay in the timing of generating the braking force is compensated for by reducing the clearance amount from the reference clearance amount by an amount corresponding to the delay according to a reduction from the maximum current. The “condition 1” includes reducing the clearance amount from the reference clearance amount for the four wheels when the vehicle 1 satisfies a condition under which the actuation of the collision mitigation brake (AEB) is predicted, such as when an obstacle is present ahead in the traveling direction of the vehicle 1.

The “condition 2” corresponds to reducing the clearance amount from the reference clearance amount only for the front wheels 2L and 2R based on the running environment such as the road state (the road condition) or the vehicle state. In this case, how much the clearance amount should be reduced is set according to a concept similar to the “condition 1” with the aim of improving the responsiveness.

The “condition 3” corresponds to increasing the clearance amount from the reference clearance amount only for the corresponding wheel based on the running environment such as the road state (the road condition) or the vehicle state, and reducing the clearance amount from the reference clearance amount for a wheel other than that. In this case, the wheel for which the clearance amount is reduced and the wheel for which the clearance amount is increased are determined in consideration of the distribution of the braking force of the brake with the aim of maintaining the brake performance. Further, for example, how much the clearance amount should be reduced is determined based on a greatest amount not affecting the running, and how much the clearance amount should be increased can be determined based on this reduced clearance amount, to compensate for a reduction in the responsiveness of the wheel for which the clearance amount is increased by the wheel for which the clearance amount is reduced.

The “condition 4” corresponds to increasing the clearance amount from the reference clearance amount only for the rear wheels 3L and 3R based on the running environment such as the road state (the road condition) or the vehicle state. In this case, how much the clearance amount should be increased is determined with the aim of reducing the drag torque. More specifically, the drag torque is kept constant when the clearance is widened to a certain amount or more. Therefore, how much the clearance amount should be increased can be set to a clearance amount at which the drag torque starts to be stabilized.

Then, the priority order of the independent control of adjusting the clearance amount independently for each of the wheels 2L, 2R, 3L, and 3R is set to the order of the “condition 1”, the “condition 2”, the “condition 3”, and the “condition 4” from the perspective of ensuring safety. However, if both the “condition 1” and the “condition 2”, which are conditions on the clearance amount reduction side, are satisfied while safety can be ensured, control as a combination of the “condition 1” and the “condition 2” is performed with the intention to maximize the braking performance. In other words, in this case, the clearance amount is reduced for the front wheels 2L and 2R and the corresponding wheel (all of the wheels 2L, 2R, 3L, and 3R if necessary).

The setting of the clearance amount, i.e., how much the clearance amount should be reduced or increased from the reference clearance amount will be described with reference to FIG. 6. FIG. 6 illustrates examples of the relationships between the clearance amount, and the responsiveness and the drag torque. In FIG. 6, a clearance amount indicated by a short broken line represents a target clearance amount under normal circumstances, i.e., the reference clearance amount. The reference clearance amount is set to a clearance amount that satisfies both a responsiveness target and a drag torque target, i.e., a clearance amount at which the responsiveness characteristic and the drag torque characteristic intersect with each other. Then, when the clearance amount is reduced from the reference clearance amount the clearance amount is set so as to, for example, achieve a responsiveness improvement target defined individually by the brake control predicted to intervene as illustrated in FIG. 6. At this time, if there is a plurality of responsiveness improvement targets, the clearance amount can be appropriately set by being set so as to achieve the highest responsiveness improvement target. Although the drag torque increases due to the reduction in the clearance amount for the reference clearance amount, this is just a temporary phenomenon only on the corresponding wheel and therefore less affects the deterioration of the fuel efficiency. On the other hand, when the clearance amount is increased from the reference clearance amount the clearance amount is set to, for example, a clearance amount at which the drag torque starts to be stabilized.

When the clearance amount between the brake pad 25 and the disk rotor D is reduced, the piston 24 is advanced farther toward the brake pad 25 side than the position occupied under normal circumstances (i.e., the position corresponding to the target clearance amount under normal circumstances). On the other hand, when the clearance amount between the brake pad 25 and the disk rotor D is increased, the piston 24 is moved farther toward the opposite side from the brake pad 25 than the position occupied under normal circumstances (i.e., the position corresponding to the target clearance amount under normal circumstances).

The processing flows illustrated in FIGS. 4 and 5 are flows of control processing for adjusting (setting) the clearance amount between the brake pad 25 and the disk rotor D in the braking mechanism 21 independently for each of the wheels 2L, 2R, 3L, and 3R of the vehicle 1. The processing flows illustrated in FIGS. 4 and 5 are started according to, for example, actuation of the first ECU 10, the second ECU 11, and the electric brake ECU 31. The processing illustrated in FIGS. 4 and 5 is repeatedly performed per predetermined control cycle.

In the following description, the processing in FIGS. 4 and 5 will be described assuming that this is performed by the first ECU 10 by way of example. However, the processing in FIGS. 4 and 5 may be performed by, for example, the second ECU 11, or may be performed by any electric brake ECU 31. Alternatively, for example, the processing in FIGS. 4 and 5 may be performed by both the first ECU 10 and the second ECU 11 independently of each other. In this case, the embodiment may be configured in such a manner that any one of the first ECU 10 and the second ECU 11 outputs a final processing result (respective control instructions for the clearance amount) after determining consistency between the processing result yielded by the first ECU 10 and the processing result yielded by the second ECU 11. Further alternatively, the processing in FIGS. 4 and 5 may be performed by the first ECU 10, the second ECU 11, and the electric brake ECU 31 as a whole. Further alternatively, the processing in FIGS. 4 and 5 may be performed by an ECU different from the first ECU 10, the second ECU 11, and the electric brake ECU 13.

After the processing in FIGS. 4 and 5 is started, in S1, the first ECU 10 reads in each sensing value. More specifically, in S1, the first ECU 10 reads in a detection value (a signal) from a detection device for detecting the external world around the vehicle 1 (a running environment acquisition device) such as an in-vehicle camera, an infrared radar, a millimeter-wave radar, an external temperature sensor, a raindrop sensor, a position sensor (GPS), or a navigation system (map data) mounted on the vehicle 1, and/or a detection device for detecting the state (the condition) of the vehicle 1 itself (a vehicle state acquisition device) such as an acceleration sensor, a speed sensor, a wheel speed sensor, a brake hydraulic pressure sensor, a brake pedal sensor, an accelerator pedal sensor, or a temperature sensor of a vehicle component mounted on the vehicle 1.

In S2 subsequent to S1, the first ECU 10 determines whether the “condition 1” is satisfied. More specifically, in S2, the first ECU 10 determines whether the clearance amount should be reduced from the reference clearance amount, which is the clearance amount under normal circumstances, only for the corresponding wheel based on the running environment such as the road state (the road condition) or the vehicle state. For example, the first ECU 10 determines whether the vehicle 1 is in a state of being unable to supply the maximum current to the electric motor 26 that actuates the braking mechanism 21, or whether the brake control of controlling the braking force independently for each of the wheels 2L, 2R, 3L, and 3R is predicted to intervene.

If the determination in S2 is “YES”, i.e., the “condition 1” is determined to be satisfied, the processing proceeds to S3. For example, if it is determined that the vehicle 1 is in the state of being unable to supply the maximum current or the intervention of the brake control is predicted, the processing proceeds to S3. On the other hand, if the determination in S2 is “NO”, i.e., the “condition 1” is determined not to be satisfied, the processing proceeds to S7. For example, if it is determined that the vehicle 1 is in the state of being able to supply the maximum current or the intervention of the brake control is not predicted, the processing proceeds to S7.

In S3, the first ECU 10 determines whether the “condition 2” is satisfied. More specifically, in S3, the first ECU 10 determines whether the clearance amount should be reduced from the reference clearance amount only for the front wheels 2L and 2R based on the running environment such as the road state (the road condition) or the vehicle state. For example, the first ECU 10 determines whether the vehicle 1 is predicted to be braked. If the determination in S3 is “YES”, i.e., the “condition 2” is determined to be satisfied, the processing proceeds to S4. For example, if the vehicle 1 is determined to be predicted to be braked, the processing proceeds to S4. In S4, the first ECU 10 sets the clearance amount between the disk rotor D and the brake pad 25 for each of the wheels 2L, 2R, 3L, and 3R. More specifically, in S4, the first ECU 10 reduces (narrows) the target clearance amount for the front wheels 2L and 2R and the corresponding wheel. Further, in S4, the first ECU 10 sets the target clearance amount without changing it for a wheel other than the front wheels 2L and 2R and the corresponding wheel. The corresponding wheel is, for example, a wheel corresponding to the electric motor 26 to which the maximum current cannot be supplied or a wheel on which the intervention of the brake control is predicted.

In such S4, the first ECU 10 sets the clearance amount for each of the front wheels 2L and 2R and the corresponding wheel to a clearance amount smaller than the reference clearance amount, and sets the clearance amount for the wheel other than the front wheels 2L and 2R and the corresponding wheel to the reference clearance amount. In S5 subsequent to S4, the first ECU 10 notifies a clearance acquisition portion of the clearance amount set in S4. In other words, in SS subsequent to $4, the first ECU 10 outputs a control instruction to the electric brake ECU 31 of each of the wheels 2L, 2R, 3L, and 3R so as to achieve the clearance amount set in S4. After the control instruction is output to the electric brake ECU 31 of each of the wheels 2L, 2R, 3L, and 3R in S5, the processing is ended. In other words, the processing returns to “START” via “END”, followed by repetition of the processing in and after S1.

On the other hand, if the determination in S3 is “NO”, i.e., the “condition 2” is determined not to be satisfied, the processing proceeds to $6. For example, if the vehicle 1 is determined not to be predicted to be braked, the processing proceeds to S6. In S6, the first ECU 10 sets the clearance amount between the disk rotor D and the brake pad 25 for each of the wheels 2L, 2R, 3L, and 3R. More specifically, in S6, the first ECU 10 reduces (narrows) the target clearance amount for the corresponding wheel. Further, in S6, the first ECU 10 sets the target clearance amount for a wheel other than the corresponding wheel without changing it. The corresponding wheel is, for example, a wheel corresponding to the electric motor 26 to which the maximum current cannot be supplied or a wheel on which the intervention of the brake control is predicted.

In such S6, the first ECU 10 sets the clearance amount for the corresponding wheel to a clearance amount smaller than the reference clearance amount, and sets the clearance amount for the wheel other than the corresponding wheel to the reference clearance amount. In S5 subsequent to S6, the first ECU 10 notifies the clearance acquisition portion of the clearance amount set in S6. In other words, in S5 subsequent to S6, the first ECU 10 outputs the control instruction to the electric brake ECU 31 of each of the wheels 2L, 2R, 3L, and 3R so as to achieve the clearance amount set in S6. Then, the processing is ended.

On the other hand, if the determination in S2 is “NO”, the processing proceeds to S7. In S7, the first ECU 10 determines whether the “condition 2” is satisfied similarly to S3. If the determination in S7 is “YES”, i.e., the “condition 2” is determined to be satisfied, the processing proceeds to S8. For example, if the vehicle 1 is determined to be predicted to be braked, the processing proceeds to S8. In S8, the first ECU 10 sets the clearance amount between the disk rotor D and the brake pad 25 for each of the wheels 2L, 2R, 3L, and 3R. More specifically, in S8, the first ECU 10 reduces (narrows) the target clearance amount for each of the front wheels 2L and 2R. Further, in S8, the first ECU 10 sets the target clearance amount for a wheel other than the front wheels 2L and 2R (i.e., the rear wheels 3L and 3R) without changing it.

In such S8, the first ECU 10 sets the clearance amount for each of the front wheels 2L and 2R to a clearance amount smaller than the reference clearance amount, and sets the clearance amount for the wheel other than the front wheels 2L and 2R (i.e., the rear wheels 3L and 3R) to the reference clearance amount. In S5 subsequent to S8, the first ECU 10 notifies the clearance acquisition portion of the clearance amount set in $8. In other words, in S5 subsequent to S8, the first ECU 10 outputs the control instruction to the electric brake ECU 31 of each of the wheels 2L, 2R, 3L, and 3R so as to achieve the clearance amount set in S8. Then, the processing is ended.

On the other hand, if the determination in S7 is “NO”, i.e., the “condition 2” is determined not to be satisfied, the processing proceeds to S9. For example, if the vehicle 1 is determined not to be predicted to be braked, the processing proceeds to S9. In S9, the first ECU 10 determines whether the “condition 3” is satisfied. More specifically, in S9, the first ECU 10 determines whether the clearance amount should be increased from the reference clearance amount for the corresponding wheel and should be reduced from the reference clearance amount for a wheel other than that based on the running environment such as the road state (the road condition) or the vehicle state. For example, the first ECU 10 determines whether the temperature is higher than a predetermined temperature on at least one of the wheel 2L, 2R, 3L, or 3R, the disk rotor D, the brake pad 25, or the braking mechanism 21. In this case, the predetermined temperature can be set in consideration of expansion, a performance change, or the like due to a temperature increase. For example, the predetermined temperature can be set as a temperature (a border value) that necessitates improving the air-cooling efficiency by increasing the clearance amount upon exceedance over this temperature.

If the determination in S9 is “YES”, i.e., the “condition 3” is determined to be satisfied, the processing proceeds to S10. For example, if the temperature regarding any of the braking mechanisms 21 is determined to be higher than the predetermined temperature, the processing proceeds to S10. In S10, the first ECU 10 sets the clearance amount between the disk rotor D and the brake pad 25 for each of the wheels 2L, 2R, 3L, and 3R. More specifically, in S10, the first ECU 10 increases (widens) the target clearance amount for the corresponding wheel. Further, in S10, the first ECU 10 reduces (narrows) the target clearance amount for a wheel other than the corresponding wheel. The corresponding wheel is, for example, a wheel corresponding to the braking mechanism 21 having a high temperature.

In such S10, the first ECU 10 sets the clearance amount for the corresponding wheel to a clearance amount greater than the reference clearance amount, and sets the clearance amount for the wheel other than the corresponding wheel to a clearance amount smaller than the reference clearance amount. In SS subsequent to S10, the first ECU 10 notifies the clearance acquisition portion of the clearance amount set in S10. In other words, in S5 subsequent to S10, the first ECU 10 outputs the control instruction to the electric brake ECU 31 of each of the wheels 2L, 2R, 3L, and 3R so as to achieve the clearance amount set in $10. Then, the processing is ended.

On the other hand, if the determination in S9 is “NO”, i.e., the “condition 3” is determined not to be satisfied, the processing proceeds to S11 in FIG. 5 via “A” in FIGS. 4 and 5. For example, if the temperatures regarding all the braking mechanisms 21 are determined not to be higher than the predetermined temperature, the processing proceeds to S11. In S11, the first ECU 10 determines whether the “condition 4” is satisfied. More specifically, in S11, the first ECU 10 determines whether the clearance amount should be increased from the reference clearance amount only for the rear wheels 3L and 3R based on the running environment such as the road state (the road condition) or the vehicle state. For example, the first ECU 10 determines whether the vehicle 1 is in a state where no sudden braking occurs or whether the braking force required for the vehicle I can be supplemented by the regenerative braking.

If the determination in S11 is “YES”, i.e., the “condition 4” is determined to be satisfied, the processing proceeds to S12. For example, if it is determined that the vehicle 1 is in the state where no sudden braking occurs or the braking force required for the vehicle 1 can be supplemented by the regenerative braking, the processing proceeds to S12. In S12, the first ECU 10 sets the clearance amount between the disk rotor D and the brake pad 25 for each of the wheels 2L, 2R, 3L, and 3R. More specifically, in S12, the first ECU 10 increases (widens) the target clearance amount only for the rear wheels 3L and 3R. Further, in S12, the first ECU 10 sets the target clearance amount for a wheel other than the rear wheels 3L and 3R (i.e., the front wheels 2L and 2R) without changing it.

In such S12, the first ECU 10 sets the clearance amount for each of the rear wheels 3L and 3R to a clearance amount greater than the reference clearance amount, and sets the clearance amount for the wheel other than the rear wheels 3L and 3R (i.e., the front wheels 2L and 2R) to the reference clearance amount. After the clearance amount is set in S12, the processing proceeds to S5 in FIG. 4 via “B” in FIGS. 5 and 4. In S5 subsequent to S12, the first ECU 10 notifies the clearance acquisition portion of the clearance amount set in S12. In other words, in S5 subsequent to S12, the first ECU 10 outputs the control instruction to the electric brake ECU 31 of each of the wheels 2L, 2R, 3L, and 3R so as to achieve the clearance amount set in S12. Then, the processing is ended.

On the other hand, if the determination in S11 is “NO”, i.e., the “condition 4” is determined not to be satisfied, the processing proceeds to S13. For example, if it is determined that the vehicle 1 is not in the state where no sudden braking occurs or the braking force required for the vehicle 1 cannot be supplemented by the regenerative braking, the processing proceeds to S13. In S13, the first ECU 10 sets the clearance amount between the disk rotor D and the brake pad 25 for each of the wheels 2L, 2R, 3L, and 3R. More specifically, in S13, the first ECU 10 sets the target clearance amount for all of the wheels without changing it. In such S13, the first ECU 10 sets the clearance amount for each of all of the wheels 2L, 2R, 3L, and 3R to the reference clearance amount. In S5 subsequent to S13, the first ECU 10 notifies the clearance acquisition portion of the clearance amount set in S13. In other words, in S5 subsequent to S13, the first ECU 10 outputs the control instruction to the electric brake ECU 31 of each of the wheels 2L, 2R, 3L, and 3R so as to achieve the clearance amount set in S13. Then, the processing is ended.

In this manner, in the embodiment, the vehicle 1 includes the braking mechanism 21, the first ECU 10, the second ECU 11, and the electric brake ECU 31. At least one of the first ECU 10, the second ECU 11, or the electric brake ECU 31 (hereinafter also referred to as the ECU(s) 10, 11, and/or 31) corresponds to the vehicle control apparatus. The braking mechanism 21 presses the brake pads 25 against the disk rotor D rotating together with the wheel 2L, 2R, 3L, or 3R. The ECUs 10, 11, and 31 include control portions 10A, 11A, and 31A that control the braking mechanisms 21, respectively. The ECU(s) 10, 11, and/or 31 correspond(s) to a control unit mounted on the vehicle 1 including the braking mechanism 21. The ECU(s) 10, 11, and/or 31 (i.e., the control portion(s) 10A, 11A, and/or 31A) perform(s) the following control.

That is, the ECU(s) 10, 11, and/or 31 (the control portion(s) 10A, 11A, and/or 31A) acquire(s) a control condition including at least one of information regarding the running environment of the running road on which the vehicle 1 runs or information regarding the state of the vehicle 1. In this case, the ECU(s) 10, 11, and/or 31 (the control portion(s) 10A, 11A, and/or 31A) acquire(s) the information regarding the running environment or the information regarding the state of the vehicle 1 directly from a detection device that acquires this information (an information acquisition device) or via the CAN 12 or the like. Examples of the information regarding the running environment include a road shape (a road curvature, a slope, a road width, and the like), the position of an obstacle, a road state (u), weather, a temperature, a humidity, and a traffic condition. Further, examples of the information regarding the state of the vehicle 1 include the vehicle motion state (braking, a speed, an acceleration, a jerk, and the like), and the state of the vehicle itself (the state of the actuator, sensing accuracy, and the like). Then, the ECU(s) 10, 11, and/or 31 (the control portion(s) 10A, 11A, and/or 31A) control(s) the clearance amount between the disk brake D and the brake pad 25 independently for each of the wheels 2L, 2R, 3L, and 3R of the vehicle 1 based on the acquired control condition.

In this case, the control condition can be the information regarding the running environment. The information regarding the running environment can be, for example, acquired from the detection device for recognizing the external world around the vehicle 1 (the running environment acquisition device), such as an in-vehicle camera, an infrared radar, a millimeter-wave radar, an external temperature sensor, a raindrop sensor, a position sensor (GPS), or a navigation system (map data). When the brake control of controlling the braking force independently for each of the wheels 2L, 2R, 3L, and 3R is predicted to intervene according to the information regarding the running environment, the control portion(s) 10A, 11A, and/or 31A perform(s) control for reducing the clearance amount from the reference clearance amount for the wheel on which the brake control intervenes (the corresponding wheel) among the wheels 2L, 2R, 3L, and 3R.

“When the brake control is predicted to intervene” corresponds to, for example, “when entry into a curve, a road surface under a rainy, snowy, or icy condition, the presence of an obstacle lying ahead, or the like is recognized based on a video image captured by the in-vehicle camera”. Alternatively, “when the brake control is predicted to intervene” corresponds to, for example, “when entry into a curve is recognized based on the map data of the navigation system or the like and the present position”, “when raining is recognized based on the raindrop sensor”, and “when shortness of the distance between vehicles is recognized based on the infrared radar or the millimeter-wave radar”. Examples of the brake control performed independently for each of the four wheels include the sideslip prevention control, the GV control, the moment control, and the collision mitigation brake control. In this case, this brake control includes not only brake control that applies the braking force to only one of the four wheels but also brake control that applies the braking forces to two wheels, three wheels, or four wheels among the four wheels.

Further, for example, the GV control and the moment control are performed based on the lateral jerk of the vehicle 1. Therefore, the intervention of the brake control may be predicted based on the vehicle motion state estimated (calculated) from the information regarding the running environment. In other words, “performing the control according to the information regarding the running environment” includes not only performing the control directly using the “information regarding the running environment” itself but also performing the control using the “information regarding the state of the vehicle 1 (for example, the vehicle motion state)” that is acquired by being estimated from the “information regarding the running environment”.

Further, the information regarding the running environment is a curvature of a road lying ahead of the running road on which the vehicle 1 runs. In this case, the road curvature can be acquired from, for example, a video image captured by the in-vehicle camera or the map data of the navigation system or the like and the present position. The acquisition of the road curvature makes it possible to predict the intervention of the brake control of controlling the braking force independently for each of the wheels 2L, 2R, 3L, and 3R, such as the sideslip prevention control, the GV control, the moment control, or the collision mitigation brake control.

Alternatively, the control condition can be, for example, the information regarding the state of the vehicle 1. The information regarding the state of the vehicle 1 can be acquired from the detection device for detecting the state (the condition) of the vehicle 1 itself (the vehicle state acquisition device) such as an acceleration sensor, a speed sensor, a wheel speed sensor, a brake hydraulic pressure sensor, a brake pedal sensor, an accelerator pedal sensor, or a temperature sensor of a vehicle component mounted on the vehicle 1. Further, for example, the vehicle motion state in the information regarding the state of the vehicle 1 may be acquired using the sensor value itself or may be acquired using information estimated from the “information regarding the running environment” (for example, the lateral jerk estimated from the road curvature and the vehicle speed).

Further, the information regarding the state of the vehicle I can be information regarding the braking of the vehicle 1. In this case, the control portion(s) 10A, 11A, and/or 31A perform(s) control for reducing the clearance amount from the reference clearance amount for the front wheels 2L and 2R among the wheels 2L, 2R, 3L, and 3R when the vehicle 1 is predicted to be braked. “When the vehicle 1 is predicted to be braked” corresponds to, for example, “when a release of the accelerator pedal is detected by the accelerator pedal sensor”. The “prediction of the braking of the vehicle 1” may be directly made using the “information regarding the state of the vehicle 1 (for example, information about the accelerator pedal)” itself or may be made using the “information regarding the state of the vehicle 1 (for example, the vehicle motion state)” that is acquired by being estimated from the “information regarding the running environment”.

Alternatively, the information regarding the state of the vehicle I can be the temperature including at least one of the wheel 2L, 2R, 3L, or 3R, the disk rotor D, the brake pad 25, or the braking mechanism 21. In this case, the control portion(s) 10A, 11A, and/or 31A perform(s) control for increasing the clearance amount from the reference clearance amount for the wheel where the temperature is higher than the predetermined temperature (the corresponding wheel) among the wheels 2L, 2R, 3L, and 3R. Further, the control portion(s) 10A, 11A, and/or 31A perform(s) control for reducing the clearance amount from the reference clearance amount for the wheel where the temperature is equal to or lower than the predetermined temperature (the wheel other than the corresponding wheel) among the wheels 2L, 2R, 3L, and 3R. The predetermined temperature can be set as, for example, the temperature (the border value) that necessitates improving the air-cooling efficiency by increasing the clearance amount upon exceedance over this temperature.

In the embodiment, the braking mechanism 21 is actuated by the electric motor 26. Then, the maximum current suppliable to the electric motor 26 is used as the information regarding the state of the vehicle 1. In this case, the control portion(s) 10A, 11A, and/or 31A perform(s) control for reducing the clearance amount from the reference clearance amount for the wheel corresponding to the electric motor 26 to which the maximum current is determined to be unable to be supplied among the electric motors 26 corresponding to the wheels 2L, 2R, 3L, and 3R, respectively (the corresponding wheel).

On the other hand, when determining that no sudden braking occurs based on the information regarding the running environment or the braking force required for the vehicle 1 can be supplemented by the regenerative braking based on the information regarding the state of the vehicle 1, the control portion(s) 10A, 11A, and/or 31A perform(s) control for increasing the clearance amount from the reference clearance amount for the rear wheels among the wheels 2L, 2R, 3L, and 3R.

Further, in the embodiment, the control condition includes the first condition (the condition 1), the second condition (the condition 2), the third condition (the condition 3), and the fourth condition (the condition 4). The first condition includes the information regarding the maximum current suppliable to the electric motor 26 that actuates the braking mechanism 21 in the information regarding the state of the vehicle 1 or the brake control of controlling the braking force independently for each of the wheels 2L, 2R, 3L, and 3R that is determined based on the information regarding the running environment. The second condition includes the information regarding the braking of the vehicle 1 in the information regarding the state of the vehicle 1. The third condition includes the temperature including at least one of the wheel 2L, 2R, 3L, or 3R, the disk rotor D, the brake pad 25, or the braking mechanism 21 in the information regarding the state of the vehicle 1. The fourth condition includes the information regarding sudden braking that is determined based on the information regarding the running environment or the information regarding the regenerative braking that is determined based on the information regarding the state of the vehicle 1.

Then, the control portion(s) 10A, 11A, and/or 31A prioritize(s) the first condition among the first condition, the second condition, the third condition, and the fourth condition to use as the condition for controlling the clearance amount independently for each of the wheels 2L, 2R, 3L, and 3R of the vehicle 1. Further, the control portion(s) 10A, 11A, and/or 31A follow(s) the order of the first condition, the second condition, the third condition, and the fourth condition as the priority order of the condition for controlling the clearance amount independently for each of the wheels 2L, 2R, 3L, and 3R of the vehicle 1.

In this manner, according to the embodiment, the control portion(s) 10A, 11A, and/or 31A control(s) the clearance amount between the disk rotor D and the brake pad 25 independently for each of the wheels 2L, 2R, 3L, and 3R of the vehicle 1 based on the control condition including at least one of the “information regarding the running environment” or the “information regarding the state of the vehicle”. Due to that, the control portion(s) 10A, 11A, and/or 31A can adjust the clearance amount for each of the wheels 2L, 2R, 3L, and 3R. of the vehicle 1 independently for each of the wheels 2L, 2R, 3L, and 3R according to the control condition. For example, the control portion(s) 10A, 11A, and/or 31A can reduce the clearance amount from the reference clearance amount for some wheel among the four wheels 2L, 2R, 3L, and 3Rt and set the clearance amount equal to the reference clearance amount or increase the clearance amount from the reference clearance amount for a wheel other than that according to the control condition. As a result, both a reduction in the brake performance and an increase in the drag torque can be prevented at the same time.

According to the embodiment, the control condition is the information regarding the running environment. Therefore, the control portion(s) 10A, 11A, and/or 31A can control the clearance amount independently for each of the wheels 2L, 2R, 3L, and 3R of the vehicle 1 based on the control condition including the information regarding the running environment.

According to the embodiment, when the brake control of controlling the braking force independently for each of the wheels 2L, 2R, 3L, and 3R is predicted to intervene according to the information regarding the running environment, the control portion(s) 10A, 11A, and/or 31A reduce(s) the clearance amount from the reference clearance amount for the wheel on which the brake control intervenes among the wheels 2L, 2R, 3L, and 3R. As a result, the responsiveness can be improved on the wheel where the intervention of the brake control is predicted, and an increase in the drag torque can also be prevented on the wheel where the intervention of the brake control is not predicted.

According to the embodiment, the information regarding the running environment is the curvature of the road lying ahead of the running road on which the vehicle 1 runs. Therefore, the control portion(s) 10A, 11A, and/or 31A can control the clearance amount independently for each of the wheels 2L, 2R, 3L, and 3R of the vehicle 1 based on the control condition including the road curvature.

According to the embodiment, the control condition is the information regarding the state of the vehicle 1. Therefore, the control portion(s) 10A, 11A, and/or 31A can control the clearance amount independently for each of the wheels 2L, 2R, 3L, and 3R of the vehicle 1 based on the control condition including the information regarding the state of the vehicle 1.

According to the embodiment, the information regarding the state of the vehicle 1 is the information regarding the braking of the vehicle 1. Therefore, the control portion(s) 10A, 11A, and/or 31A can control the clearance amount independently for each of the wheels 2L, 2R, 3L, and 3R of the vehicle 1 based on the control condition including the information regarding the braking of the vehicle 1. In this case, the control portion(s) 10A, 11A, and/or 31A reduce(s) the clearance amount from the reference clearance amount for the front wheels 2L and 2R among the wheels 2L, 2R, 3L, and 3R when the vehicle 1 is predicted to be braked. As a result, the clearance amount can be reduced and the responsiveness can be improved on the front wheels 2L and 2R subjected to a high wheel load and more contributive to the brake force than the rear wheels 3L and 3R at the time of deceleration. On the other hand, an increase in the drag torque can be prevented by not reducing the clearance amount from the reference clearance amount on the rear wheels 3L and 3R among the wheels 2L, 2R, 3L, and 3R.

According to the embodiment, the information regarding the state of the vehicle 1 is the temperature including at least one of the wheel 2L, 2R, 3L, or 3R, the disk rotor D, the brake pad 25, or the braking mechanism 21. Therefore, the control portion(s) 10A, 11A, and/or 31A can control the clearance amount independently for each of the wheels 2L, 2R, 3L, and 3R of the vehicle 1 based on the temperature. In this case, the control portion(s) 10A, 11A, and/or 31A increase(s) the clearance amount from the reference clearance amount for the wheel where the temperature is higher than the predetermined temperature among the wheels 2L, 2R, 3L, and 3R, and reduce(s) the clearance amount from the reference clearance amount for the wheel where the temperature is equal to or lower than the predetermined temperature among the wheels 2L, 2R, 3L, and 3R. As a result, the disk rotor D and the brake pad 25 can be highly efficiently air-cooled on the wheel where the temperature is higher than the predetermined temperature, and a reduction in the brake performance can be prevented. Further, the responsiveness can be improved on the wheel where the temperature is equal to or lower than the predetermined temperature.

According to the embodiment, the braking mechanism 26 is actuated by the electric motor 21. As a result, a reduction in the brake performance and an increase in the drag torque can be prevented on the electrically driven and highly responsive braking mechanism 21.

According to the embodiment, the information regarding the state of the vehicle 1 is the maximum current suppliable to the electric motor 26. Therefore, the control portion(s) 10A, 11A, and/or 31A can control the clearance amount independently for each of the wheels 2L, 2R, 3L, and 3R of the vehicle 1 based on the maximum current. In this case, the control portion(s) 10A, 11A, and/or 31A reduce(s) the clearance amount from the reference clearance amount for the wheel corresponding to the electric motor 26 to which the maximum current is determined to be unable to be supplied among the electric motors 26 corresponding to the wheels 2L, 2R, 3L, and 3R, respectively. Due to that, a reduction in the responsiveness of the wheel corresponding to the electric motor 26 to which the maximum current cannot be supplied can be compensated for by reducing the clearance amount. As a result, a reduction in the brake performance can be prevented. Further, an increase in the drag torque can be prevented on the wheel corresponding to the electric motor 26 to which the maximum current can be supplied.

According to the embodiment, when no sudden braking occurs or the required braking force can be supplemented by the regenerative braking, the control portion(s) 10A, 11A, and/or 31A increase(es) the clearance amount from the reference clearance amount for the rear wheels 3L and 3R among the wheels 2L, 2R, 3L, and 3R. As a result, an increase in the drag torque can be prevented by increasing the clearance amount for the rear wheels 3L and 3R less contributive to the brake force than the front wheels 2L and 2R. Further, a reduction in the responsiveness can be prevented by not increasing the clearance amount for the front wheels 2L and 2R more contributive to the brake force than the rear wheels 3L and 3R.

According to the embodiment, the control portion(s) 10A, 11A, and/or 31A prioritize(s) the first condition including the information regarding the “maximum current suppliable to the electric motor 26” or the “brake control of controlling the braking force independently for each of the wheels 2L, 2R, 3L, and 3R” to use as the condition for controlling the clearance amount independently for each of the wheels 2L, 2R, 3L, and 3R of the vehicle 1. Therefore, priority can be placed on reducing the clearance amount from the reference clearance amount for the wheel corresponding to the electric motor 26 to which the maximum current is determined to be unable to be supplied or reducing the clearance amount from the reference clearance amount for the wheel on which the intervention of the brake control is predicted among the wheels 2L, 2R, 3L, and 3R.

According to the embodiment, the control portion(s) 10A, 11A, and/or 31A follows the order of the first condition, the second condition, the third condition, and the fourth condition as the priority order of the condition for controlling the clearance amount independently for each of the wheels 2L, 2R, 3L, and 3R of the vehicle 1. Therefore, the highest priority can be placed on reducing the clearance amount from the reference clearance amount for the wheel corresponding to the electric motor 26 to which the maximum current is determined to be unable to be supplied or reducing the clearance amount from the reference clearance amount for the wheel on which the intervention of the brake control is predicted among the wheels 2L, 2R, 3L, and 3R. Subsequently, the next priority can be placed on reducing the clearance amount from the reference clearance amount for the front wheels 2L and 2R among the wheels 2L, 2R, 3L, and 3R when the vehicle 1 is predicted to be braked. Subsequently, the third priority can be placed on increasing the clearance amount from the reference clearance amount for the wheel where the temperature is higher than the predetermined temperature among the wheels 2L, 2R, 3L, and 3R and reducing the clearance amount from the reference clearance amount for the wheel where the temperature is equal to or lower than the predetermined temperature among the wheels 2L, 2R, 3L, and 3R. Further, the fourth priority can be placed on increasing the clearance amount from the reference clearance amount for the rear wheels 3L and 3R among the wheels 2L, 2R, 3L and 3R when no sudden braking occurs or the required braking force can be supplemented by the regenerative braking.

The embodiment has been described citing the example in which the left front wheel-side electric brake apparatus 5L and the right rear wheel-side electric brake apparatus 6R are controlled by the control portion 10A of the first ECU 10, and the right front wheel-side electric brake apparatus 5R and the left rear wheel-side electric brake apparatus 6L are controlled by the control portion 11A of the second ECU 11. However, without being limited thereto, for example, the right front wheel-side electric brake apparatus 5R and the left rear wheel-side electric brake apparatus 6L may be controlled by the control portion 10A of the first ECU 10, and the left front wheel-side electric brake apparatus 5L and the right rear wheel-side electric brake apparatus 6R may be controlled by the control portion 11A of the second ECU 11.

The embodiment has been described citing the example in which the braking mechanism 21 is a so-called floating caliper-type disk brake configured in such a manner that the piston 24 is provided on the inner side of the caliper 23. However, without being limited thereto, the brake mechanism may be, for example, a so-called opposed piston-type disk brake configured in such a manner that pistons are provided on the inner side and the outer side of the caliper, respectively.

The embodiment has been described citing the example in which the braking mechanism 21 is a disk brake. However, without being limited thereto, the brake mechanism may be, for example, a drum brake that presses a shoe (the frictional pad) against a drum rotor (the rotor) rotating together with the wheel.

The embodiment has been described citing the example in which the braking mechanism 21 is the electric brake actuated by the electric motor 26. However, without being limited thereto, the brake mechanism may be provided also using, for example, a hydraulic brake actuated by a hydraulic pressure (a brake hydraulic pressure). For example, the hydraulic brake may be used as the brake mechanism on the front wheel side, or the hydraulic brake may be used as the brake mechanism on the four wheels. In such a case, the clearance amount can be controlled independently for each of the wheels by, for example, employing such a configuration that a brake hydraulic pressure is supplied to the brake mechanism by a hydraulic pressure supply device such as an ESC. In this case, the clearance amount can be reduced by, for example, increasing (supplying) the brake hydraulic pressure introduced from the ESC to the brake mechanism from the atmospheric pressure under normal circumstances.

The embodiment has been described citing the example in which the first ECU 10, the second ECU 11, and the electric brake ECU 31 are assumed to correspond to the vehicle control apparatus including the control portion(s) 10A, 11A, and/or 31A configured to control the braking mechanism 21. In other words, the embodiment has been described citing the example in which the first ECU 10, the second ECU 11, and the electric brake ECU 31 are assumed to correspond to the control unit mounted on the vehicle. However, without being limited thereto, for example, the first ECU 10 and the second ECU 11 may be constituted by one ECU, or the first ECU 10, the second ECU 11, and the electric brake ECU 31 may be constituted by one ECU.

Further, the vehicle control apparatus (the control unit) that controls the clearance amount independently for each of the wheels may be the first ECU 10, may be the second ECU 11, may be the electric brake ECU 31, or may be another ECU. In other words, the function that controls the clearance amount independently for each of the wheels of the vehicle can be provided to any ECU (the vehicle control apparatus or the control unit) mounted on the vehicle.

According to the above-described embodiment, the control portion (i.e., the control unit) controls the clearance amount between the rotor and the frictional pad independently for each of the wheels of the vehicle based on the control condition including at least one of the “information regarding the running environment” or the “information regarding the state of the vehicle”. Due to that, the control portion can adjust the clearance amount for each of the wheels of the vehicle independently for each of the wheels. For example, the control portion can reduce the clearance amount from the reference clearance amount for some wheel among a plurality of wheels, and set the clearance amount equal to the reference clearance amount or increase the clearance amount from the reference clearance amount for a wheel other than that, according to the control condition. As a result, both a reduction in the brake performance and an increase in the drag torque can be prevented at the same time.

According to the embodiment, the control condition is the information regarding the running environment. Therefore, the control portion can control the clearance amount independently for each of the wheels of the vehicle based on the control condition including the information regarding the running environment.

According to the embodiment, when the brake control of controlling the braking force independently for each of the wheels is predicted to intervene according to the information regarding the running environment, the control portion reduces the clearance amount from the reference clearance amount for the wheel on which the brake control intervenes among the wheels. As a result, the responsiveness can be improved on the wheel where the intervention of the brake control is predicted, and an increase in the drag torque can also be prevented on the wheel where the intervention of the brake control is not predicted.

According to the embodiment, the information regarding the running environment is the curvature of the road lying ahead of the running road on which the vehicle runs. Therefore, the control portion can control the clearance amount independently for each of the wheels of the vehicle based on the control condition including the road curvature.

According to the embodiment, the control condition is the information regarding the state of the vehicle. Therefore, the control portion can control the clearance amount independently for each of the wheels of the vehicle based on the control condition including the information regarding the state of the vehicle.

According to the embodiment, the information regarding the state of the vehicle is the information regarding the braking of the vehicle. Therefore, the control portion can control the clearance amount independently for each of the wheels of the vehicle based on the control condition including the information regarding the braking of the vehicle. In this case, the control portion reduces the clearance amount from the reference clearance amount for the front wheel among the wheels when the vehicle is predicted to be braked. As a result, the clearance amount can be reduced and the responsiveness can be improved on the front wheel subjected to a high wheel load and more contributive to the brake force than the rear wheel at the time of deceleration. On the other hand, an increase in the drag torque can be prevented by not reducing the clearance amount from the reference clearance amount on the rear wheel among the wheels.

According to the embodiment, the information regarding the state of the vehicle is the temperature including at least one of the wheel, the rotor, the frictional pad, or the braking mechanism. Therefore, the control portion can control the clearance amount independently for each of the wheels of the vehicle based on the temperature. In this case, the control portion increases the clearance amount from the reference clearance amount for the wheel where the temperature is higher than the predetermined temperature among the wheels, and reduces the clearance amount from the reference clearance amount for the wheel where the temperature is equal to or lower than the predetermined temperature among the wheels. As a result, the rotor and the frictional pad are highly efficiently air-cooled on the wheel where the temperature is higher than the predetermined temperature, and a reduction in the brake performance can be prevented. Further, the responsiveness can be improved on the wheel where the temperature is equal to or lower than the predetermined temperature.

According to the embodiment, the braking mechanism is actuated by the electric motor. As a result, a reduction in the brake performance and an increase in the drag torque can be prevented on the electrically driven and highly responsive braking mechanism.

According to the embodiment, the information regarding the state of the vehicle is the maximum current suppliable to the electric motor. Therefore, the control portion can control the clearance amount independently for each of the wheels of the vehicle based on the maximum current. In this case, the control portion reduces the clearance amount from the reference clearance amount for the wheel corresponding to the electric motor to which the maximum current is determined to be unable to be supplied among the electric motors corresponding to the wheels, respectively. Due to that, a reduction in the responsiveness of the wheel corresponding to the electric motor to which the maximum current cannot be supplied can be compensated for by reducing the clearance amount. As a result, a reduction in the brake performance can be prevented. Further, an increase in the drag torque can be prevented on the wheel corresponding to the electric motor to which the maximum current can be supplied.

According to the embodiment, when no sudden braking occurs or the required braking force can be supplemented by the regenerative braking, the control portion increases the clearance amount from the reference clearance amount for the rear wheel among the wheels. As a result, an increase in the drag torque can be prevented by increasing the clearance amount for the rear wheel less contributive to the brake force than the front wheel. Further, a reduction in the responsiveness can be prevented by not increasing the clearance amount for the front wheel more contributive to the brake force than the rear wheel.

According to the embodiment, the control portion prioritizes the first condition including the information regarding the “maximum current suppliable to the electric motor” or the “brake control of controlling the braking force independently for each of the wheels” to use as the condition for controlling the clearance amount independently for each of the wheels of the vehicle. As a result, priority can be placed on reducing the clearance amount from the reference clearance amount for the wheel corresponding to the electric motor to which the maximum current is determined to be unable to be supplied or reducing the clearance amount from the reference clearance amount for the wheel on which the intervention of the brake control is predicted among the wheels.

According to the embodiment, the control portion follows the order of the first condition, the second condition, the third condition, and the fourth condition as the priority order of the condition for controlling the clearance amount independently for each of the wheels of the vehicle. Therefore, the highest priority can be placed on reducing the clearance amount from the reference clearance amount for the wheel corresponding to the electric motor to which the maximum current is determined to be unable to be supplied or reducing the clearance amount from the reference clearance amount for the wheel on which the intervention of the brake control is predicted among the wheels. Subsequently, the next priority can be placed on reducing the clearance amount from the reference clearance amount for the front wheel among the wheels when the vehicle is predicted to be braked. Subsequently, the third priority can be placed on increasing the clearance amount from the reference clearance amount for the wheel where the temperature is higher than the predetermined temperature among the wheels, and reducing the clearance amount from the reference clearance amount for the wheel where the temperature is equal to or lower than the predetermined temperature among the wheels. Further, the fourth priority can be placed on increasing the clearance amount from the reference clearance amount for the rear wheel among the wheels when no sudden braking occurs or the required braking force can be supplemented by the regenerative braking.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2021-194100 filed on Nov. 30, 2021. The entire disclosure of Japanese Patent Application No. 2021-194100 filed on Nov. 30, 2021 including the specification, the claims, the drawings, and the abstract is incorporated herein by reference in its entirety.

### REFERENCE SIGNS LIST

1 vehicle
2, 2L, 2R front wheel (wheel)
3, 3L, 3R rear wheel (wheel)
10 first ECU (vehicle control apparatus or control unit)
10A control portion
11 second ECU (vehicle control apparatus or control unit)
11A control portion
21 braking mechanism
25 brake pad (frictional pad)
26 electric motor
31 electric brake ECU (vehicle control apparatus or control unit)
31A control portion
D disk rotor (rotor)

1. A vehicle control apparatus comprising:
a control portion configured to control a braking mechanism, the braking mechanism being configured to press a frictional pad against a rotor that rotates together with a wheel,
wherein the control portion
acquires a control condition including at least one of information regarding a running environment of a running road on which a vehicle runs or information regarding a state of the vehicle, and
controls a clearance amount between the rotor and the frictional pad independently for each of wheels of the vehicle based on the control condition.

2. The vehicle control apparatus according to claim 1, wherein the control condition is the information regarding the running environment.

3. The vehicle control apparatus according to claim 2, wherein, when brake control of controlling a braking force independently for each of the wheels is predicted to intervene according to the information regarding the running environment, the control portion performs control for reducing the clearance amount from a reference clearance amount for a wheel on which the brake control intervenes among the wheels.

4. The vehicle control apparatus according to claim 3, wherein the information regarding the running environment is a curvature of a road lying ahead of the running road on which the vehicle runs.

5. The vehicle control apparatus according to claim 1, wherein the control condition is the information regarding the state of the vehicle.

6. The vehicle control apparatus according to claim 5, wherein the information regarding the state of the vehicle is information regarding braking of the vehicle, and
wherein, when the vehicle is predicted to be braked, the control portion controls for reducing the clearance amount from a reference clearance amount for a front wheel among the wheels.

7. The vehicle control apparatus according to claim 5, wherein the information regarding the state of the vehicle is a temperature of at least one of the wheel, the rotor, the frictional pad, or the braking mechanism, and
wherein the control portion performs control for increasing the clearance amount from the reference clearance amount for a wheel where the temperature is higher than a predetermined temperature among the wheels, and performs control for reducing the clearance amount from the reference clearance amount for a wheel where the temperature is equal to or lower than the predetermined temperature among the wheels.

8. The vehicle control apparatus according to claim 1, wherein the braking mechanism is actuated by an electric motor.

9. The vehicle control apparatus according to claim 8, wherein the information regarding the state of the vehicle is a maximum current suppliable to the electric motor, and
wherein the control portion performs control for reducing the clearance amount from a reference clearance amount for a wheel corresponding to an electric motor to which the maximum current is determined to be unable to be supplied among the electric motors corresponding to the wheels, respectively.

10. The vehicle control apparatus according to claim 1, wherein, when it is determined that no sudden braking occurs based on the information regarding the running environment or a braking force required for the vehicle can be supplemented by regenerative braking based on the information regarding the state of the vehicle, the control portion performs control for increasing the clearance amount from a reference clearance amount for a rear wheel among the wheels.

11. The vehicle control apparatus according to claim 1, wherein the control condition includes
a first condition including information regarding a maximum current suppliable to an electric motor configured to actuate the braking mechanism in the information regarding the state of the vehicle or brake control of controlling a braking force independently for each of the wheels that is determined based on the information regarding the running environment,
a second condition including information regarding braking of the vehicle in the information regarding the state of the vehicle,
a third condition including a temperature of at least one of the wheel, the rotor, the frictional pad, or the braking mechanism in the information regarding the state of the vehicle, and
a fourth condition including information regarding sudden braking that is determined based on the information regarding the running environment or information regarding regenerative braking that is determined based on the information regarding the state of the vehicle, and
wherein the control portion prioritizes the first condition among the first condition, the second condition, the third condition, and the fourth condition to use as a condition for controlling the clearance amount independently for each of the wheels of the vehicle.

12. The vehicle control apparatus according to claim 11, wherein the control portion prioritizes the first condition, the second condition, the third condition, and the fourth condition in this order as the condition for controlling the clearance amount independently for each of the wheels of the vehicle.

13. A vehicle control method configured to be performed by a control unit mounted on a vehicle including a braking mechanism, the braking mechanism being configured to press a frictional pad against a rotor that rotates together with a wheel, the vehicle control method comprising:
causing the control unit to
acquire a control condition including at least one of information regarding a running environment of a running road on which a vehicle runs or information regarding a state of the vehicle, and
control a clearance amount between the rotor and the frictional pad independently for each of wheels of the vehicle based on the control condition.
